(19) United States
(12) Patent Application Publication
(10) Pub. No.: US 2024/0369313 A1
(43) Pub. Date: Nov. 7, 2024

(54) INTERFACE FOR COOLING PLATE COOLANT MANIFOLD

(71) Applicant: AMPERE S.A.S., Boulogne Billancourt (FR)

(72) Inventors: Philippe RECOUVREUR, Guyancourt (FR); Christophe ROBIN, Guyancourt (FR)

(73) Assignee: AMPERE S.A.S., Boulogne Billancourt (FR)

(21) Appl. No.: 18/689,269

(22) PCT Filed: Aug. 24, 2022
(86) PCT No.: PCT/EP2022/073585

§ 371 Date: Jul. 10, 2024

(30) Foreign Application Priority Data
Sep. 15, 2021 (FR) 2109698

(51) Int. Cl. F28F 9/02; H01M 10/613; H01M 10/625; H01M 10/6554; H01M 10/6556; H01M 10/6568

(52) U.S. Cl. CPC F28F 9/0263; H01M 10/613; H01M 10/625; H01M 10/6554; H01M 10/6556; H01M 10/6568; F28F 2009/0297; F28F 2210/10; H01M 2220/20

(57) ABSTRACT

An interface for a coolant manifold of a cooling plate includes a first main face intended to be connected to a coolant manifold, and a second main face intended to be connected to a cooling plate having at least two flow paths for the circulation of a coolant. The second main face includes at least two holes of different geometries respectively allowing a circulation of coolant between the coolant manifold and each of the at least two flow paths of the cooling plate.

The invention relates to an interface for a cooling plate coolant manifold. The invention also relates to an assembly comprising a cooling plate equipped with such an interface. The invention further relates to a thermal management system for a battery comprising such an interface or such an assembly. The invention also relates to a vehicle equipped with such an interface, with such an assembly or with such a thermal management system.

In the automotive industry, the re-use of existing components plays a part in the strategies aimed at reducing the design and production costs of new vehicle models.

Such is notably the case of the coolant manifolds used to circulate coolant through the cooling plates, or water plates, of electric batteries. However, the use of water manifolds referred to as “standard”, which is to say ones that are common to a number of models of vehicles, must not be made at the expense of the thermal management of the battery. Specifically, the thermal management requirements of the battery may vary from one vehicle to another and the use of a standard coolant manifold must not limit the consideration given to these differences.

Document CN109728381A discloses a method for designing a water plate employing fluid-passage cross sections that are customized in such a way as to concentrate the flow in those regions of the plate where the heat dissipation requirements are the greatest. This solution makes it possible to use the same water plate, and therefore the same water manifold, to meet different thermal management requirements.

However, this solution has drawbacks. In particular, such a plate cannot be customized to suit the thermal management requirements of all batteries. Certain batteries may require the use of a different water plate, notably a water plate of different dimensions. This device therefore does not meet the customization requirements needed for it to be possible to use a standard water manifold.

The object of the invention is to provide a device that overcomes the above drawbacks and improves the devices known from the prior art. In particular, the invention makes it possible to create a device which is simple and reliable and which allows a standard water manifold to be used with different water plates while at the same time optimizing the thermal management of the battery.

To this end, the invention relates to an interface for a cooling plate coolant manifold, the interface comprising
a first main face intended to be connected to a coolant manifold, and
a second main face intended to be connected to a cooling plate having at least two passages for the circulation of a coolant, the second main face comprising at least two holes of different geometries respectively allowing coolant to circulate between the coolant manifold and each of the at least two passages of the cooling plate.

In one embodiment, the interface is intended to be connected to a cooling plate positioned near a face of a battery in order to cool same, said face of a battery comprising at least a first zone and a second zone which are such that the temperature of the first zone is significantly greater than the temperature of the second zone when the battery is in operation, the cooling plate having at least two passages for the circulation of coolant, a first of the at least two passages being the closest to the first zone, and a second of the at least two passages being the closest to the second zone, the first and second passages each being supplied with coolant via two distinct holes of the at least two holes of different geometries, and the hole that supplies the first passage with coolant has a larger cross-sectional area than the hole that supplies the second passage with coolant.

In one embodiment, the interface is intended to be connected to a cooling plate upstream or downstream of a cooling plate relative to a direction of circulation of a coolant in a cooling plate.

In one embodiment, the interface is made of aluminum.

The invention also relates to an assembly comprising:
at least an interface according to the invention,
two water manifolds, and
a cooling plate.

In a first embodiment of the assembly, the cooling plate being intended to cool a battery comprising at least one battery module, the at least one battery module being of given length X,
the cooling plate comprises Y coolant circulation passages
and the Y passages of the cooling plate are spaced apart from one another by a distance X/(Y+1).

In the first embodiment of the assembly, the at least one interface may have Y holes.

The invention also relates to a system for the thermal management of an electric battery, comprising at least an interface according to the invention or an assembly according to the invention.

The invention additionally relates to a motor vehicle comprising an electric battery and a thermal management system according to the invention.

The attached drawing depicts, by way of example, one embodiment of a water manifold interface according to the invention, one embodiment of an assembly comprising a cooling plate equipped with an interface according to the invention, and one embodiment of a thermal management system for a battery comprising such an interface or such an assembly.

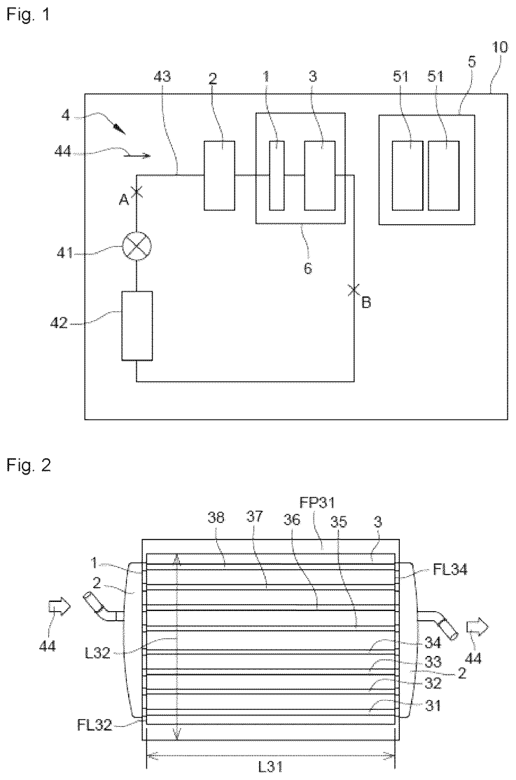

FIG. 1 depicts one embodiment of a motor vehicle equipped with a water manifold interface according to the invention.

FIG. 2 depicts one embodiment of a cooling plate.

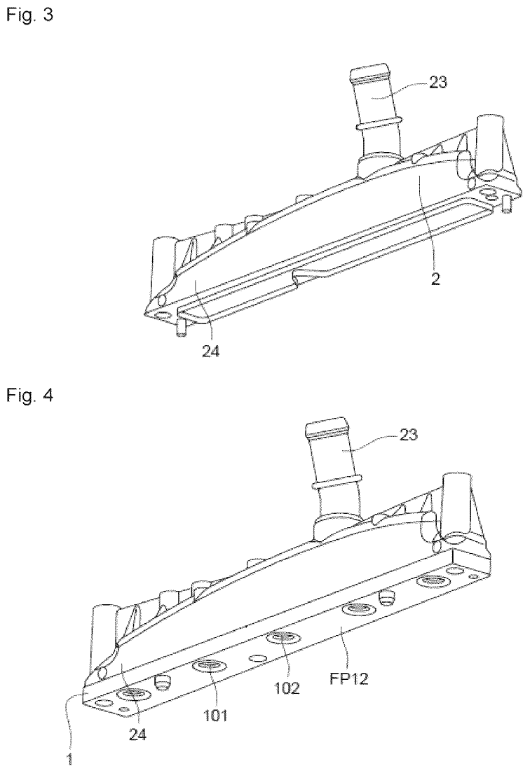

FIG. 3 depicts one embodiment of a standard water manifold.

FIG. 4 depicts one embodiment of a standard water manifold equipped with a water manifold interface.

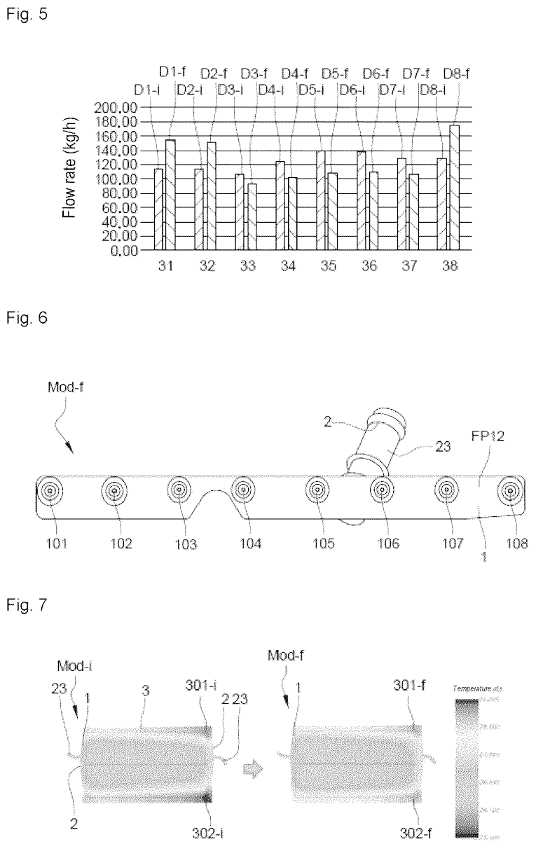

FIG. 5 illustrates the coolant flow rates obtained respectively in each of the passages of a cooling plate of an interface 1 successively according to a first and according to a second embodiment.

FIG. 6 illustrates one embodiment of a water manifold interface.

FIG. 7 depicts a first and a second cooling-plate temperature distribution, these distributions being obtained by equipping the water manifold with an interface according to a first embodiment and according to a second embodiment, respectively.

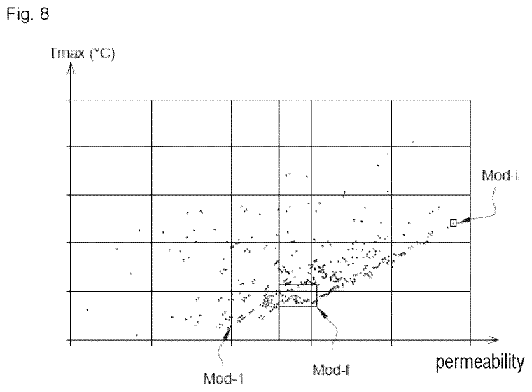

FIG. 8 is a graph representing all of the simulations carried out in order to calibrate the interface 1.

One embodiment of a motor vehicle 10 according to the invention is described hereinbelow with reference to FIG. 1. The motor vehicle 10 is a motor vehicle of electric or hybrid type, notably a passenger vehicle or a utility vehicle.

The motor vehicle 10 is equipped with a battery 5 according to the invention, of the lithium or Li-ion type. The battery 5 could equally be a battery referred to as being of all-solid-state or solid-state electrolyte type.

The battery 5 comprises several battery modules 51, the modules 51 comprising Li-ion battery cells 511.

The motor vehicle 10 is also equipped with a battery thermal management system 4 comprising the elements needed for circulating a coolant in the vicinity of the battery modules 51.

In one embodiment, the system 4 comprises the following elements:
a cooling plate 3 advantageously placed in contact with or in the vicinity of the battery modules 51,
two water manifolds 2 or coolant manifolds,
a pump 41,
a cooling means 42,
a circuit 43 connecting the pump 41, the cooling means 42 and the plate 3.

In the remainder of the document, the terms “manifold” or “water manifold” are used to refer to a coolant manifold. Likewise, the terms “plate” or “cooling plate” are used to refer to a water plate or to a coolant plate or to a liquid-coolant plate.

Thus, the system 4 allows coolant to circulate in a cooling direction 44. The pump 41 displaces the coolant notably between
a point A situated between the pump 41 and the plate 3, upstream of the plate 3 relative to the direction 44 of circulation of the coolant, and
a point B situated between the plate 3 and the cooling means 42, downstream of the plate 3 relative to the direction 44 of circulation of the coolant.

Between the point A and the point B, the coolant passes through the plate 3, thus circulating close to the battery modules 51 in order to cool same. The coolant temperature measured at the point B is therefore substantially higher than the coolant temperature measured at the point A.

Downstream of the point B, the fluid is then cooled by the cooling means 42 which may, for example, be a circuit in which freon gas circulates, notably in the form of a serpentine coil wound around the refrigerated portion of the circuit 43, in order to cool same.

The pump 41 is able to regulate the flow rate of the coolant circulating in the circuit 43. The fluid flow rate governs notably the amount of heat transfer between the battery modules and the coolant.

One embodiment of a cooling plate is described in FIG. 2. The cooling plate 3 is of rectangular parallelepipedal shape of length L31, width L32 and height H, having:
two opposite rectangular main faces FP31, FP32, dimensions L31×L32, one of the main faces FP31, FP32 being intended to be placed in the vicinity of or in contact with the battery modules 51,
two lateral faces FL31, FL33, of dimensions L31×H, and
two lateral faces FL32, FL34, of dimensions L32×H, the lateral face FL32 being situated upstream of the lateral face FL34 with respect to the direction 44 of circulation of the coolant.

In this embodiment, the plate 3 has eight passages 31 to 38 which are rectilinear and of length L31, allowing the coolant to circulate inside the cooling plate, from the lateral face FL32, referred to as the inlet face, to the lateral face FL34, referred to as the outlet face. The eight passages thus create eight distinct fluid flows in the cooling plate.

In one embodiment, the passages 31 to 38 of the cooling plate 3 are created by extrusion and are commonly referred to as “multiport extruded channels”. Other embodiments of the passages are conceivable, for example using molding.

In order to allow the coolant to circulate in the plate 3, the circuit 43 is advantageously connected to the plate 3 via two water manifolds 2. Notably, the inlet face FL32 and the outlet face FL34 are connected (directly or indirectly) to a first and to a second manifold, respectively.

FIG. 3 depicts one embodiment of a water manifold 2. The water manifold comprises a pipe-shaped end 23 enabling it to be connected to the circuit 43, and a wide open end 24, preferably of elongate shape, enabling it to be connected notably to one of the inlet or outlet faces FL32, FL34 of the plate 3.

In the embodiment of the invention that is illustrated in FIG. 4, at least one of the two manifolds is further equipped with a manifold interface 1, the interface being interposed between the manifold and the cooling plate 3.

The manifold interface 1 is a hollow part; its outline is a rectangular parallelepiped of which the length and width suit the dimensions of the open end 24 of the water manifold 2. The interface 1 has a first and a second main face FP11, FP12, and four lateral faces.

The interface 1 may be made of aluminum. In one embodiment, its length may be 250 millimeters, its width may be between 30 and 40 millimeters, and its thickness may be 5 millimeters. The dimensions and shape of the interface 1 may vary according to the dimensions and shape of the manifold 2 and of the plate 3.

The first main face FP11 of the interface 1 is intended to be connected to the water manifold 2. In one embodiment, it has a wide opening O1, advantageously suited to the dimensions of the wide open end 24 of the manifold 2. Thus, when the opening O1 of the interface 1 is fixed facing the opening 24 of the manifold 2, all of the coolant entering the manifold 2 via the end 23 is collected by the interface 1.

The second main face FP12 is intended to be connected to the cooling plate 3. The second main face FP12 has at least two holes 101, 102 for the passage of the coolant. It is intended to be fixed to one of the lateral inlet or outlet faces FL32, FL34 of the cooling plate 3. Advantageously, when the second main face FP12 is fixed to one of the lateral inlet or outlet faces FL32, FL34 of the plate 3, the at least two holes 101, 102 lie facing at least a first and a second passage of the plate 3, respectively.

Thus, when the second main face FP12 of the interface 1 is hermetically fixed to the lateral inlet face FL32 of the plate 3, all of the coolant entering the interface 1 via the opening O1 is distributed between the at least two passages situated facing the at least two holes 101, 102. In other words, the coolant
enters the manifold 2 via the pipe-shaped end 23,
passes through the manifold 2 and the interface 1,
enters at least two passages in the cooling plate via the at least two holes 101, 102.

Likewise, when the second main face FP12 of the interface 1 is hermetically fixed to the lateral outlet face FL34 of the plate 3, all of the coolant entering the interface 1 via the least two holes 101, 102 converges toward the opening O1 situated facing the wide open end 24 of the manifold 2. In other words, the coolant
exits the cooling plate 3 via the at least two holes situated facing at least two passages in the plate 3,
passes through the interface 1, then
passes through the manifold 2 to re-emerge, via the end 23, in the circuit 43.

The interface 1 therefore allows a water manifold 2 to be connected to a cooling plate 3 without the water manifold and the cooling plate needing to be specifically designed to work together. Specifically, the geometric shape of the interface 1, notably the geometric shape of its main faces FP11, FP12, can easily be adapted to allow a coolant to circulate between a given water manifold and a given cooling plate.

Furthermore, the interface allows the fluid circulation to be adapted to suit the spatial distribution of the heat generated by the battery modules 51, and do so without requiring modification to the water manifold 2 or to the plate 3. The objective of adapting the coolant circulation to suit is to render the battery temperature more uniform in order to limit temperature spikes in given zones of the battery.

To this end, at least two holes 101, 103 of the interface 1 may have different geometries. For a cooling plate having N passages, an interface 1 according to the invention may have between 2 and N holes, at least two of the N holes having different geometries and each of the holes being positioned facing a distinct passage in the cooling plate 3.

For example, in the embodiment depicted in FIG. 6, the interface 1 has 8 holes, 101 to 108, such that the holes 101, 102, 108 situated at the ends of the interface 1 are of greater diameter than the holes 103 to 107 situated in the central part of the interface, the diameter of the circular holes 101, 102, 108 notably being 6 millimeters, and that of the circular holes 103 to 107 being 4 millimeters.

The interface 1 depicted in FIG. 6 may be used upstream and/or downstream of the plate 3 depicted in FIG. 2. In this embodiment, the interface 1 provides one hole for each passage in the plate 3, the holes 101 to 108 respectively supplying the passages 31 to 38 of the plate. Because their diameter is greater than that of the other holes of the interface, the holes 101, 102, 108 generate a greater coolant flow rate in the passages 31, 32 and 38, relative to the other passages 33 to 37 of the plate 3.

The interface 1 according to the invention thus allows the fluid flow rate in each passage of the cooling plate to be calibrated independently so as to optimize the cooling of the battery modules 51. In other words, the diameter of each of the holes of the interface is calculated so as to regulate, in each passage of the cooling plate, the coolant flow rate that will allow the battery temperature to be reduced and rendered more uniform.

FIGS. 5 and 7 illustrate the effect of an interface 1 according to the invention, through two embodiments of the interface 1:
an initial embodiment Mod_i, prior to optimization of the diameter of the holes of the interface,
a final embodiment Mod_f, after optimization of the diameter of the holes of the interface.

FIG. 5 illustrates the coolant flow rates (in kilograms per hour) obtained respectively in each of the eight passages 31 to 38 of a cooling plate 3 equipped, successively, with an interface 1 according to the initial embodiment Mod_i and then with an interface 1 according to the final embodiment Mod_f.

In the initial embodiment Mod_i, the initial flow rate values D1_i to D8i are comprised between 100 and 140 kg/h, the flow rates D1_i to D3_i being comprised between 100 and 120 kg/h, and the flow rates D4_i to D8_i being comprised between 120 and 140 kg/h.

In the final embodiment Mod_f, the final flow rate values D1_f to D8_f are comprised between 90 and 175 kg/h, the flow rates D3_f to D7_f being comprised between 90 and 110 kg/h, and the flow rates D1_f, D2_f and D8_f being comprised between 140 and 175 kg/h.

In the example of FIG. 5, it may be seen that an interface 1 according to the final embodiment Mod_f imposes, in the lateral passages 31, 32 and 38, a flow rate that is 50% higher than the flow rate in the other passages 33 to 37. In addition, the maximum flow rate in the final embodiment Mod_f is 50% higher than the maximum flow rate in the initial embodiment Mod_i.

FIG. 7 illustrates the effect of an interface 1 according to the invention on the thermal management of the battery. Specifically, views V1 and V2 respectively depict a first and a second cooling-plate temperature distribution, these distributions being obtained by equipping the water manifold 2 with an interface 1 according to the initial embodiment Mod_i and then according to the final embodiment Mod_f.

The first view V1, with use of an interface 1 according to the initial embodiment Mod_i, reveals two zones 301_i, 302_i in which the temperature is significantly higher than in the rest of the plate 3. The second view V2, with use of an interface 1 according to the final embodiment Mod_f, reveals that these same two zones 301_f, 302_f have a temperature which is closer to that of the center of the plate 3.

The invention therefore makes it possible to improve the performance of the cooling plate by adjusting the geometries of the holes in the interface. The improvement can be seen through two indicators: the maximum temperature Tmax_i, Tmax_f measured on the plate 3, and the thermal resistance coefficient Rth_i, Rth_f of the plate, which indicates the ability of a material (in this instance the plate) to prevent the heat from passing through it. These two parameters are significantly improved between the initial embodiment Mod_i and the final embodiment Mod_f:
the maximum temperature measured in the final embodiment Tmax_f (29.5° C.) is around 2° lower than the maximum temperature measured in the initial embodiment Tmax_i (31.2° C.),
the thermal resistance measured in the final embodiment (Rth_f=8.10⁻³ K/W) is 10% lower than the thermal resistance measured in the initial embodiment (Rth_i=9.10⁻³ K/W).

Thus, implementation of the invention entails determining an optimal configuration for the interface 1—namely the number, position and geometry of the holes arranged on the second main face FP12 of the interface 1—according to the geometry of the cooling plate 3 and the spatial distribution of the heat generated by the battery modules 51.

For example, for an interface according to the invention, comprising at least two holes of different geometries 101, 103, and which is intended to be connected to a cooling plate situated in the vicinity of a face of a battery in order to cool same,
if the face of the battery comprises at least a first zone and a second zone which are such that the temperature of the first zone is significantly greater than the temperature of the second zone when the battery is in operation, and if the cooling plate has at least two passages 31, 33 for the circulation of coolant, a first of the at least two passages 31, 33 being the closest to the first zone, and a second of the at least two passages 31, 33 being the closest to the second zone, the first and second passages each being supplied with coolant via two distinct holes of the at least two holes 101, 103 of different geometries,
then, in one embodiment, the hole that supplies the first passage with coolant will have a larger cross-sectional area than the hole that supplies the second passage with coolant, the cross-sectional area being measured perpendicular to the direction of flow of the coolant.

In order to determine an optimal configuration for the interface 1, numerous configurations of the interface 1 (number, position and geometry of the holes in the interface) are simulated using 3-D computation software. For each given configuration of the interface, the software determines the spatial distribution of the battery temperature, notably the maximum temperature reached at the hottest point of the battery.

The graph G1 of FIG. 8 is a representation of all of the simulations carried out in order to calibrate the interface 1 depicted in FIG. 6, each point on the graph G1 representing one simulation. The abscissa axis represents the permeability of the assembly made up of the interface 1 and the plate 3, expressed in mm². The higher the permeability, the lower the power needed for the operation of the pump 41. Thus, a point situated in the right-hand part of the graph represents an interface 1 that will require less energy to power the pump 41 than a point situated in the left-hand part of the graph.

The ordinate axis represents the maximum temperature reached in a zone of the battery.

The point Mod_i represents, for example, a configuration of the interface 1 that generates a permeability of 74 mm² and a maximum temperature of 32.1° C. in a given zone of the battery. The configuration corresponding to the point Mod_i lies among the high values for temperature and permeability. In other words, in the embodiment associated with the point Mod_i, the use of the interface 1 does not require significant additional energy at the pump 41, although the thermal regulation of the battery is not optimal.

Conversely, the point Mod_1 represents a configuration of the interface 1 that generates a permeability of 60 mm² and a maximum temperature of 30.1° C. in a given zone of the battery. The configuration corresponding to the point Mod_1 lies among the low values for temperature and permeability. In other words, in the embodiment associated with the point Mod_1, the thermal regulation of the battery is optimal although the use of the interface 1 requires additional energy at the pump 41.

Intermediate embodiments, for example lying in an optimal zone Z1, make it possible to regulate the battery temperature while at the same time minimizing the impact that the interface 1 has in terms of additional energy consumption for operating the pump 41. The embodiment Mod_f has been selected from in the optimal zone Z1.

In the example illustrated by the graph G1, the optimal zone is determined by a plateau corresponding to a collection of simulations for which the maximum battery temperature remains constant while the permeability of the interface 1 decreases. In alternative embodiments, the optimization of the interface 1 could take other criteria into consideration.

Following the process of optimizing the design of the interface 1 by 3-D simulation, the adopted configuration for the interface 1 (number, position and geometry of the holes in the interface) can be produced quickly and easily.

The process of optimizing the cooling of the battery 5 therefore relies in part on the design of the interface 1. The simplicity with which the interface 1 is designed and produced means that this component does not need to be modified until late in the life of the project, giving flexibility in the design of the other parts of the system 4, notably the cooling plate 3 or the manifold 2.

Finally, the interface 1 according to the invention simultaneously allows:
a standard water manifold 2 to be connected to a cooling plate 3, since the dimensions and number of passages in the plate can be varied, and
the circulation of coolant in said plate 3 to be optimized to ensure optimal spatial distribution of the battery temperature,
the possibility of optimizing the battery cooling to be maintained until late in the vehicle development process.

The invention also relates to an assembly consisting of the interface 1 and a generic cooling plate.

In one embodiment, the generic cooling plate could be designed so that its dimensions are determined according to the dimensions of the battery 5 that is to be cooled.

For example, for a battery comprising one or more battery modules 51, each battery module 51 being of length X, the associated generic plate could be a plate comprising Y passages extending along the length of the module, the Y passages being spaced apart from one another by a distance X/(Y+1).

The interface 1 associated with the plate would then have Y holes the geometry of which would be optimized according to the spatial distribution of the battery temperature.

In total, the interface 1, alone or in combination with a generic plate, makes it possible to simplify the development process and reduce the costs of development of the motor vehicle 10.

Throughout this description, the term “water” has sometimes been used in place of “coolant” to express the same concept, given that coolants are often water-based.

1-9. (canceled)

10. An interface for a cooling plate of a coolant manifold, the interface comprising
a first main face configured to be connected to the coolant manifold; and
a second main face configured to be connected to the cooling plate having at least two passages for circulation of a coolant, the second main face comprising at least two holes of different geometries respectively allowing the coolant to circulate between the coolant manifold and each of the at least two passages of the cooling plate.

11. The interface as claimed in claim 10, wherein the interface is configured to be connected to the cooling plate positioned near a face of a battery in order to cool the battery,
said face of the battery comprising at least a first zone and a second zone which are such that a temperature of the first zone is significantly greater than a temperature of the second zone when the battery is in operation,
the cooling plate having the at least two passages for the circulation of the coolant, a first of the at least two passages being closer to the first zone than a second of the at least two passages, and the second of the at least two passages being closer to the second zone than the first of the at least two passages, the first and second passages each being supplied with the coolant via two distinct holes of the at least two holes of different geometries,
the hole of the two distinct holes that supplies the first passage with the coolant has a larger cross-sectional area than the hole of the two distinct holes that supplies the second passage with the coolant.

12. The interface as claimed in claim 10, wherein the interface is configured to be connected to the cooling plate upstream or downstream of the cooling plate relative to a direction of circulation of the coolant in the cooling plate.

13. The interface as claimed in claim 10, wherein the interface is made of aluminum.

14. An assembly comprising:
at least one of the interface as claimed in claim 10;
two of the coolant manifolds; and
the cooling plate.

15. The assembly as claimed in claim 14, wherein the cooling plate is configured to cool a battery comprising at least one battery module, the at least one battery module being of given length X, wherein the cooling plate comprises Y coolant circulation passages and the Y passages of the cooling plate are spaced apart from one another by a distance X/(Y+1).

16. The assembly as claimed in claim 15, wherein the at least one of the interface has Y holes.

17. A system for thermal management of an electric battery, comprising:
the interface as claimed in claim 10.

18. A motor vehicle comprising:
an electric battery; and
the thermal management system as claimed in claim 17.
